(19) United States
(12) Patent Application Publication
(10) Pub. No.: US 2026/0267737 A1
(43) Pub. Date: Sep. 10, 2026

(54) Bit-Flipping Algorithm for Binary Asymmetric Channels

(71) Applicant: SK hynix Inc., Gyeonggi-do (KR)

(72) Inventors: Meysam ASADI, San Jose, CA (US); Fan ZHANG, San Jose, CA (US); Pengfei HUANG, San Jose, CA (US)

(21) Appl. No.: 19/069,236

(22) Filed: Mar. 4, 2025

(51) Int. Cl. G06F 11/10

(52) U.S. Cl. CPC G06F 11/106; G06F 11/1068

(57) ABSTRACT

A method and associated memory system for reading data from a memory. The method decodes with a memory controller the data read from the memory using symmetric bit-flip (BF) decoding and asymmetric bit BF decoding; iterates the symmetric BF decoding; during the iterating of the symmetric BF decoding, determines an asymmetric ratio of a) a number of errors in flipping from “0” to “1” to b) a number of errors in flipping from “1” to “0”; and compares the asymmetric ratio to an asymmetric ratio threshold in order to determine whether to continue the iterating of the symmetric BF decoding or to switch to the asymmetric BF decoding.

### BACKGROUND

### 1. Field

Embodiments of the present disclosure relate to memory systems, and method of operating such systems, particularly to the operation of solid state drives and reading and decoding data from solid state drives.

### 2. Description of the Related Art

The computer environment paradigm has shifted to ubiquitous computing systems that can be used anytime and anywhere. As a result, the use of portable electronic devices such as mobile phones, digital cameras, and notebook computers has rapidly increased. These portable electronic devices generally use a memory system having memory device(s), that is, data storage device(s). The data storage device is used as a main memory device or an auxiliary memory device of the portable electronic devices.

Data storage devices using memory devices provide excellent stability, durability, high information access speed, and low power consumption, since they have no moving parts. Examples of data storage devices having such advantages include universal serial bus (USB) memory devices, memory cards having various interfaces, and solid state drives (SSD).

The SSD may include flash memory components and a controller which includes the electronics that bridge the flash memory components to the SSD input/output (I/O) interfaces. The SSD controller can include an embedded processor that can execute functional components such as firmware (FW). The SSD functional components are device specific, and in most cases, can be updated.

The two main types of flash memory components are named after the NAND and NOR logic gates. The individual flash memory cells exhibit internal characteristics similar to those of their corresponding gates. The NAND-type flash memory may be written and read in blocks (or pages) which are generally much smaller than the entire memory space. The NOR-type flash allows a single machine word (byte) to be written to an erased location or read independently. The NAND-type operates primarily in memory cards, USB flash drives, solid-state drives, and similar products, for general storage and transfer of data.

NAND flash-based storage devices have been widely adopted because of their faster read/write performance, lower power consumption, and shock proof features. In general, however, they are more expensive compared to hard disk drives (HDD). To bring costs down, NAND flash manufacturers have been pushing the limits of their fabrication processes towards 20 nm and lower, which often leads to a shorter usable lifespan and a decrease in data reliability or Quality of Service.

In this context, embodiments of the present invention arise.

### SUMMARY

Aspects of the present invention include a method for reading data from a memory, where the method decodes with a memory controller the data read from the memory using symmetric bit-flip (BF) decoding and asymmetric bit BF decoding; iterates the symmetric BF decoding; during the iterating of the symmetric BF decoding, determines an asymmetric ratio of a) a number of errors in flipping from “0” to “1” to b) a number of errors in flipping from “1” to “0”; and compares the asymmetric ratio to an asymmetric ratio threshold in order to determine whether to continue the iterating of the symmetric BF decoding or to switch to the asymmetric BF decoding.

Further aspects of the present invention include a memory system comprising a memory device, and a controller configured to decode with a memory controller the data read from the memory using symmetric bit-flip (BF) decoding and asymmetric bit BF decoding; iterate the symmetric BF decoding; during the iterating of the symmetric BF decoding, determine an asymmetric ratio of a) a number of errors in flipping from “0” to “1” to b) a number of errors in flipping from “1” to “0”; and compare the asymmetric ratio to an asymmetric ratio threshold in order to determine whether to continue the iterating of the symmetric BF decoding or to switch to the asymmetric BF decoding.

Other features, aspects and advantages of the present invention will become clear in view of the following description and accompanying the drawings.

### BRIEF DESCRIPTION OF THE DRAWINGS

FIG. 1 is a block diagram schematically illustrating a memory system in accordance with an embodiment of the present invention.

FIG. 2 is a block diagram illustrating a memory system in accordance with an embodiment of the present invention.

FIG. 3 is a circuit diagram illustrating a memory block of a memory device of a memory system in accordance with an embodiment of the present invention.

FIG. 4 is a diagram of an exemplary memory system in accordance with an embodiment of the present invention.

FIG. 5 is a diagram of an exemplary memory system including different decoders in accordance with an embodiment of the present invention.

FIG. 6 is a depiction of a matrix of a LDPC code.

FIGS. 7A and 7B illustrate a Tanner graph representation of the LDPC code and user bits, check nodes and parity bits.

FIG. 7C is a diagram illustrating distributions of states or program voltage (PV) levels for different types of cells of a memory device.

FIG. 8 is a diagram, in accordance with one embodiment of the present invention, showing the distribution of error rates for all pages of an actual NAND device at end of life condition when read at an optimal voltage threshold.

FIG. 9A is a diagram, in accordance with another embodiment of the present invention, showing the distribution of error rates for all pages of an actual NAND device at end of life condition when read at an non-optimal history read voltage threshold.

FIG. 9B is a diagram, in accordance with another embodiment of the present invention, showing the distribution of error rates for all pages of an actual NAND device at end of life condition when read at another non-optimal history read voltage threshold.

FIG. 10 is diagram illustrating an estimated NAND asymmetric ratio in accordance with one embodiment of the present invention.

FIG. 11 is diagram illustrating a performance of the novel bit flipping algorithm in accordance with one embodiment of the present invention.

FIG. 12 is a flowchart depicting a method for reading data from a memory in accordance with one embodiment of the present invention.

### DETAILED DESCRIPTION

Various embodiments are described below in more detail with reference to the accompanying drawings. The present invention may, however, be embodied in different forms and should not be construed as limited to the embodiments set forth herein. Rather, these embodiments are provided so that this disclosure is thorough and complete and fully conveys the scope of the present invention to those skilled in the art. Moreover, reference herein to “an embodiment,” “another embodiment,” or the like is not necessarily to only one embodiment, and different references to any such phrases is not necessarily to the same embodiment(s). Throughout the disclosure, like reference numerals refer to like parts in the figures and embodiments of the present invention.

The invention can be implemented in numerous ways, including as a process; an apparatus; a system; a composition of matter; a computer program product embodied on a computer readable storage medium; and/or a processor, such as a processor suitable for executing instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ refers to one or more devices, circuits, and/or processing cores suitable for processing data, such as computer program instructions.

A detailed description of embodiments of the invention is provided below along with accompanying figures that illustrate aspects of the invention. The invention is described in connection with such embodiments, but the invention is not limited to any embodiment. The scope of the invention is limited only by the claims, and the invention encompasses numerous alternatives, modifications and equivalents. Numerous specific details are set forth in the following description in order to provide a thorough understanding of the invention. These details are provided for the purpose of example; the invention may be practiced according to the claims without some or all of these specific details. For clarity, technical material that is known in technical fields related to the invention has not been described in detail so that the invention is not unnecessarily obscured.

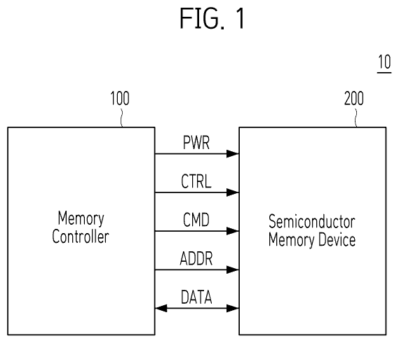

FIG. 1 is a block diagram schematically illustrating a memory system in accordance with an embodiment of the present invention.

Referring FIG. 1, the memory system 10 may include a memory controller 100 and a semiconductor memory device 200, which may represent more than one such device. The semiconductor memory device(s) 200 may be flash memory device(s).

The memory controller 100 may control overall operations of the semiconductor memory device 200.

The semiconductor memory device 200 may perform one or more erase, program, and read operations under the control of the memory controller 100. The semiconductor memory device 200 may receive a command CMD, an address ADDR and data DATA through input/output (I/O) lines. The semiconductor memory device 200 may receive power PWR through a power line and a control signal CTRL through a control line. The control signal CTRL may include a command latch enable (CLE) signal, an address latch enable (ALE) signal, a chip enable (CE) signal, a write enable (WE) signal, a read enable (RE) signal, and the like.

The memory controller 100 and the semiconductor memory device 200 may be integrated in a single semiconductor device such as a solid state drive (SSD). The SSD may include a storage device for storing data therein. When the semiconductor memory system 10 is used in an SSD, operation speed of a host (not shown) coupled to the memory system 10 may remarkably improve.

The memory controller 100 and the semiconductor memory device 200 may be integrated in a single semiconductor device such as a memory card. For example, the memory controller 100 and the semiconductor memory device 200 may be so integrated to configure a PC card of personal computer memory card international association (PCMCIA), a compact flash (CF) card, a smart media (SM) card, a memory stick, a multimedia card (MMC), a reduced-size multimedia card (RS-MMC), a micro-size version of MMC (MMCmicro), a secure digital (SD) card, a mini secure digital (miniSD) card, a micro secure digital (microSD) card, a secure digital high capacity (SDHC), and/or a universal flash storage (UFS).

In another embodiment, the memory system 10 may be provided as one of various components in an electronic device such as a computer, an ultra-mobile PC (UMPC), a workstation, a net-book computer, a personal digital assistant (PDA), a portable computer, a web tablet PC, a wireless phone, a mobile phone, a smart phone, an e-book reader, a portable multimedia player (PMP), a portable game device, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage device of a data center, a device capable of receiving and transmitting information in a wireless environment, a radio-frequency identification (RFID) device, as well as one of various electronic devices of a home network, one of various electronic devices of a computer network, one of electronic devices of a telematics network, or one of various components of a computing system.

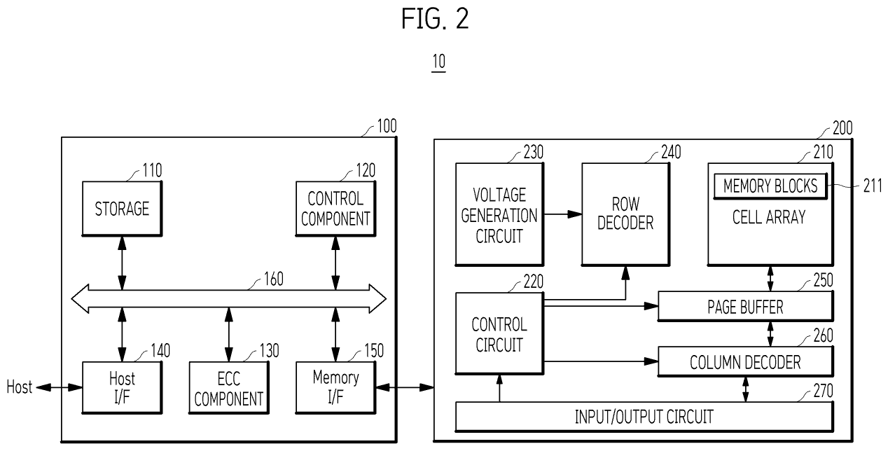

FIG. 2 is a detailed block diagram illustrating a memory system in accordance with an embodiment of the present invention. For example, the memory system of FIG. 2 may depict the memory system 10 shown in FIG. 1.

Referring to FIG. 2, the memory system 10 may include a memory controller 100 and a semiconductor memory device 200. The memory system 10 may operate in response to a request from a host device, and in particular, store data to be accessed by the host device.

The host device may be implemented with any one of various kinds of electronic devices. In some embodiments, the host device may include an electronic device such as a desktop computer, a workstation, a three-dimensional (3D) television, a smart television, a digital audio recorder, a digital audio player, a digital picture recorder, a digital picture player, and/or a digital video recorder and a digital video player. In some embodiments, the host device may include a portable electronic device such as a mobile phone, a smart phone, an e-book, an MP3 player, a portable multimedia player (PMP), and/or a portable game player.

The memory device 200 may store data to be accessed by the host device.

The memory device 200 may be implemented with a volatile memory device such as a dynamic random access memory (DRAM) and/or a static random access memory (SRAM) or a non-volatile memory device such as a read only memory (ROM), a mask ROM (MROM), a programmable ROM (PROM), an erasable programmable ROM (EPROM), an electrically erasable programmable ROM (EEPROM), a ferroelectric random access memory (FRAM), a phase change RAM (PRAM), a magnetoresistive RAM (MRAM), and/or a resistive RAM (RRAM).

The controller 100 may control storage of data in the memory device 200. For example, the controller 100 may control the memory device 200 in response to a request from the host device. The controller 100 may provide data read from the memory device 200 to the host device, and may store data provided from the host device into the memory device 200.

The controller 100 may include a storage 110, a control component 120, which may be implemented as a processor such as a central processing unit (CPU), an error correction code (ECC) component 130, a host interface (I/F) 140 and a memory interface (I/F) 150, which are coupled through a bus 160.

The storage 110 may serve as a working memory of the memory system 10 and the controller 100, and store data for driving the memory system 10 and the controller 100. When the controller 100 controls operations of the memory device 200, the storage 110 may store data used by the controller 100 and the memory device 200 for such operations as read, write, program and erase operations.

The storage 110 may be implemented with a volatile memory such as a static random access memory (SRAM) or a dynamic random access memory (DRAM). As described above, the storage 110 may store data used by the host device in the memory device 200 for the read and write operations. To store the data, the storage 110 may include a program memory, a data memory, a write buffer, a read buffer, a map buffer, and the like.

The control component 120 may control general operations of the memory system 10, and a write operation or a read operation for the memory device 200, in response to a write request or a read request from the host device. The control component 120 may drive firmware, which is referred to as a flash translation layer (FTL), to control general operations of the memory system 10. For example, the FTL may perform operations such as logical-to-physical (L2P) mapping, wear leveling, garbage collection, and/or bad block handling. The L2P mapping is known as logical block addressing (LBA).

The ECC component 130 may detect and correct errors in the data read from the memory device 200 during the read operation. The ECC component 130 may not correct error bits when the number of the error bits is greater than or equal to a threshold number of correctable error bits, and instead may output an error correction fail signal indicating failure in correcting the error bits.

The ECC component 130 may perform an error correction operation based on a coded modulation such as a low-density parity-check (LDPC) code, a Bose-Chaudhuri-Hocquenghem (BCH) code, a turbo code, a turbo product code (TPC), a Reed-Solomon (RS) code, a convolution code, a recursive systematic code (RSC), a trellis-coded modulation (TCM), or a Block coded modulation (BCM). As such, the ECC component 130 may include all circuits, systems or devices for suitable error correction operation.

The host interface 140 may communicate with the host device through one or more of various interface protocols such as a universal serial bus (USB), a multi-media card (MMC), a peripheral component interconnect express (PCI-e or PCIe), a small computer system interface (SCSI), a serial-attached SCSI (SAS), a serial advanced technology attachment (SATA), a parallel advanced technology attachment (PATA), an enhanced small disk interface (ESDI), and an integrated drive electronics (IDE).

The memory interface 150 may provide an interface between the controller 100 and the memory device 200 to allow the controller 100 to control the memory device 200 in response to a request from the host device. The memory interface 150 may generate control signals for the memory device 200 and process data under the control of the CPU 120. When the memory device 200 is a flash memory such as a NAND flash memory, the memory interface 150 may generate control signals for the memory and process data under the control of the CPU 120.

The memory device 200 may include a memory cell array 210, a control circuit 220, a voltage generation circuit 230, a row decoder 240, a page buffer 250, which may be in the form of an array of page buffers, a column decoder 260, and an input/output circuit 270. The memory cell array 210 may include a plurality of memory blocks 211 which may store data. The voltage generation circuit 230, the row decoder 240, the page buffer array 250, the column decoder 260 and the input/output circuit 270 may form a peripheral circuit for the memory cell array 210. The peripheral circuit may perform a program, read, or erase operation of the memory cell array 210. The control circuit 220 may control the peripheral circuit.

The voltage generation circuit 230 may generate operation voltages of various levels. For example, in an erase operation, the voltage generation circuit 230 may generate operation voltages of various levels such as an erase voltage and a pass voltage.

The row decoder 240 may be in electrical communication with the voltage generation circuit 230, and the plurality of memory blocks 211. The row decoder 240 may select at least one memory block among the plurality of memory blocks 211 in response to a row address RADD generated by the control circuit 220, and transmit operation voltages supplied from the voltage generation circuit 230 to the selected memory blocks.

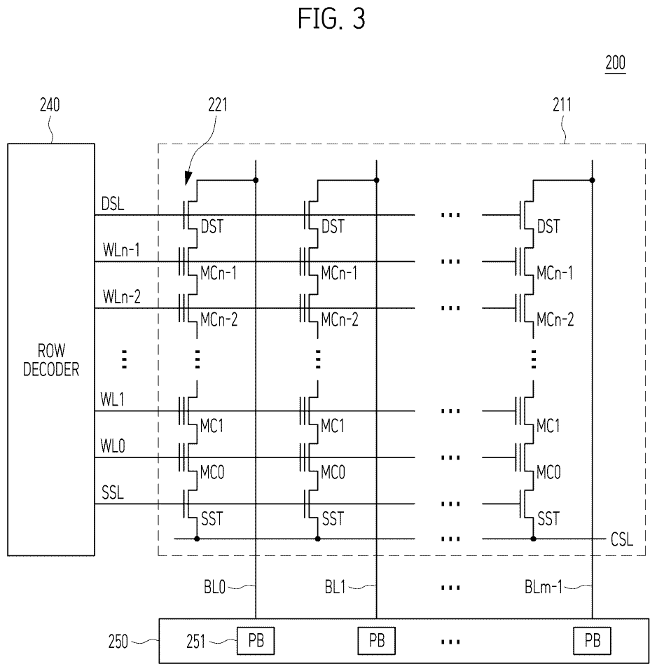

The page buffer 250 may be in electrical communication with the memory cell array 210 through bit lines BL (shown in FIG. 3). The page buffer 250 may precharge the bit lines BL with a positive voltage, transmit data to, and receive data from, a selected memory block in program and read operations, or temporarily store transmitted data, in response to page buffer control signal(s) generated by the control circuit 220.

The column decoder 260 may transmit data to, and receive data from, the page buffer 250 or transmit/receive data to/from the input/output circuit 270.

The input/output circuit 270 may transmit to the control circuit 220 a command and an address, received from an external device (e.g., the memory controller 100), transmit data from the external device to the column decoder 260, or output data from the column decoder 260 to the external device, through the input/output circuit 270.

The control circuit 220 may control the peripheral circuit in response to the command and the address.

FIG. 3 is a circuit diagram illustrating a memory block of a semiconductor memory device in accordance with an embodiment of the present invention. For example, the memory block of FIG. 3 may be any of the memory blocks 211 of the memory cell array 200 shown in FIG. 2.

Referring to FIG. 3, the exemplary memory block 211 may include a plurality of word lines WL0 to WLn-1, a drain select line DSL and a source select line SSL coupled to the row decoder 240. These lines may be arranged in parallel, with the plurality of word lines between the DSL and SSL.

The exemplary memory block 211 may further include a plurality of cell strings 221 respectively coupled to bit lines BL0 to BLm-1. The cell string of each column may include one or more drain selection transistors DST and one or more source selection transistors SST. In the illustrated embodiment, each cell string has one DST and one SST. In a cell string, a plurality of memory cells or memory cell transistors MC0 to MCn-1 may be serially coupled between the selection transistors DST and SST. Each of the memory cells may be formed as a multi-level cell (MLC) storing data information of multiple bits.

The source of the SST in each cell string may be coupled to a common source line CSL, and the drain of each DST may be coupled to the corresponding bit line. Gates of the SSTs in the cell strings may be coupled to the SSL, and gates of the DSTs in the cell strings may be coupled to the DSL. Gates of the memory cells across the cell strings may be coupled to respective word lines. That is, the gates of memory cells MC0 are coupled to corresponding word line WL0, the gates of memory cells MC1 are coupled to corresponding word line WL1, etc. The group of memory cells coupled to a particular word line may be referred to as a physical page. Therefore, the number of physical pages in the memory block 211 may correspond to the number of word lines.

The page buffer array 250 may include a plurality of page buffers 251 that are coupled to the bit lines BL0 to BLm-1. The page buffers 251 may operate in response to page buffer control signals. For example, the page buffers 251 my temporarily store data received through the bit lines BL0 to BLm-1 or sense voltages or currents of the bit lines during a read or verify operation.

In some embodiments, the memory blocks 211 may include a NAND-type flash memory cell. However, the memory blocks 211 are not limited to such cell type, but may include NOR-type flash memory cell(s). Memory cell array 210 may be implemented as a hybrid flash memory in which two or more types of memory cells are combined, or one-NAND flash memory in which a controller is embedded inside a memory chip.

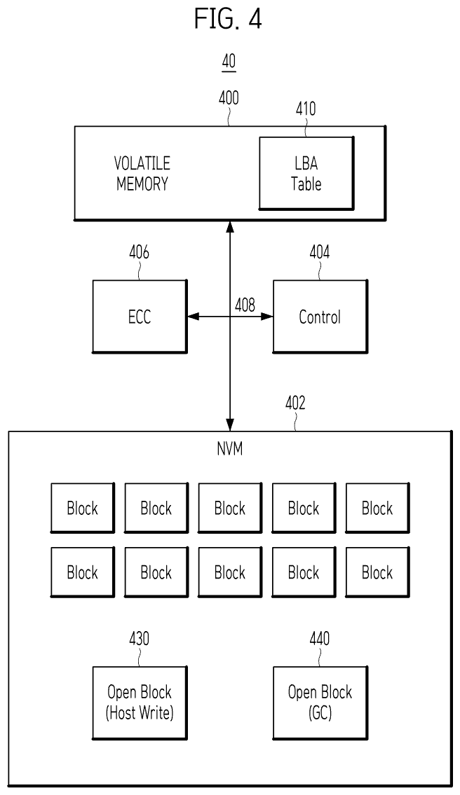

Referring to FIG. 4, a general example of a memory system 40 is schematically illustrated. The memory system 40 may include a volatile memory 400 (e.g., a DRAM), a non-volatile memory (NVM) 402 (e.g., NAND), a control component or control logic 404, such as described herein, an error correcting code (ECC) module 406, such as described herein, and a bus 408 through which these components of the memory system 40 communicate. The volatile memory 400 may include a logical bit address LBA table 410 for mapping physical-to-logical addresses of bits. The NVM 402 may include a plurality of memory blocks (and/or a plurality of super memory blocks), as well as an open block for host writes 430 and an open block for garbage collection (GC) 440. The memory system 40 shows a general memory system. Additional/alternative components that may be utilized with memory systems to effectuate the present invention will be understood to those of skill in the art in light of this disclosure.

As referred to herein, terms such as “NAND” or “NVM” may refer to non-volatile memories such as flash memories which may implement error correcting code processes. Further, “DRAM” may refer to volatile memories which may include components such as controllers and ECC modules.

In embodiments of the present invention, the memory system 10 may include multiple decoders that are configured to decode low-density parity-check (LDPC) codes.

There are many iterative decoding algorithms for LDPC codes, such as bit-flipping (BF) decoding algorithms, belief-propagation (BP) decoding algorithms, sum-product (SP) decoding algorithms, min-sum (MS) decoding algorithms, and Min-Max decoding algorithms.

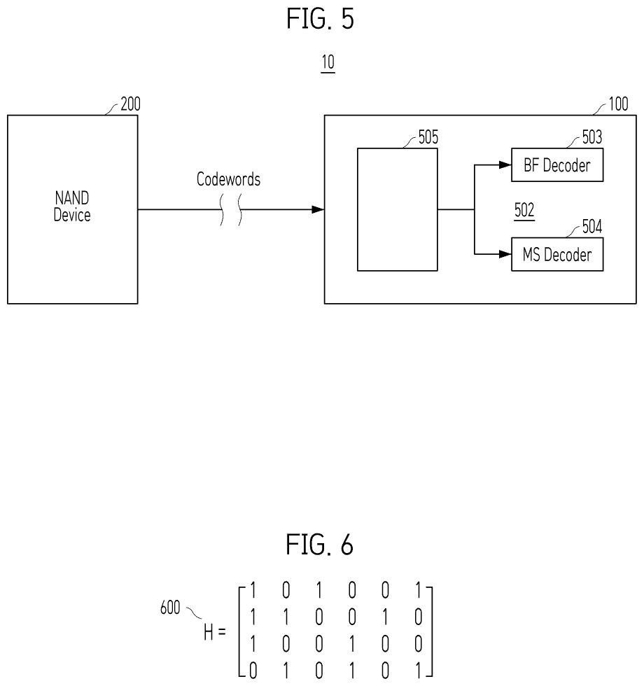

In accordance with embodiments of the present invention, and as shown in FIG. 5, the memory system 10 may include the memory device 200, which may be a NAND device, and the memory controller 100. The memory system 10 may include decoding assembly 502, which includes a bit-flipping (BF) decoder 503 to execute a BF decoding algorithm to decode codewords read from the memory device 501 and a min-sum (MS) decoder 504 to execute an MS decoding algorithm. The BF decoder 503 and the MS decoder 504 may be embodied in the ECC component 130 (shown in FIG. 1) in the memory controller 100 or in any other suitable location. The codewords received from the memory device 200 by the memory controller 100 may be temporarily stored in a buffer or storage 505 of the memory controller 100 before being passed to one or the other of the decoders. In one embodiment of the present invention, the MS decoder 504 is a hybrid precision MS decoder (noted above and described in more detail below).

The memory system 10 may include other components (not shown) such as a checksum module, which computes checksums of codewords retrieved from the memory device 200 before decoding. The checksum module may be embodied within the memory controller 100 before the storage 505. The memory system 10 may further include cyclic redundancy check (CRC) modules disposed downstream of the BF decoder 503 and MS decoder 504, respectively. The CRC modules may be embodied within the memory controller 100.

With respect to the two decoding algorithms, MS decoding, performed by its associated decoder 504, is more powerful due to its higher complexity required to process soft input information. However, the less powerful BF decoding, performed by its associated decoder 503, is useful when the number of errors is low.

MS decoding can be used as part of an iterative LDPC decoding. LDPC codes are linear block codes defined by a sparse parity-check matrix H, which consists of zeros and ones. The term “sparse matrix” is used herein to refer to a matrix in which a number of non-zero values in each column and each row is much less than its dimension. The term “column weight” is used herein to refer to the number of non-zero values in a specific column of the parity-check matrix H. The term “row weight” is used herein to refer to number of non-zero values in a specific row of the parity-check matrix H. In general, if column weights of all of the columns in a parity-check matrix corresponding to an LDPC code are similar, the code is referred to as a “regular” LDPC code. On the other hand, an LDPC code is called “irregular” if at least one of the column weights is different from other column weights. Usually, irregular LDPC codes provide better error correction capability than regular LDPC codes.

LDPC codes are usually represented by bipartite graphs. One set of nodes, the variable or bit nodes correspond to elements of the codeword and the other set of nodes, e.g., check nodes, correspond to the set of parity-check constraints satisfied by the codeword. Typically, the edge connections are chosen at random. The error correction capability of an LDPC code is improved if cycles of short length are avoided in the graph. In a (r,c) regular code, each of the n variable nodes (V1, V2, . . . , Vn) has connections to r check nodes and each of the m check nodes (C1, C2, . . . , Cm) has connections to c bit nodes. In an irregular LDPC code, the check node degree is not uniform. Similarly, the variable node degree is not uniform. In QC-LDPC codes, the parity-check matrix H is structured into blocks of p×p matrices such that a bit in a block participates in only one check equation in the block, and each check equation in the block involves only one bit from the block. In QC-LDPC codes, a cyclic shift of a codeword by p results in another codeword. Here p is the size of square matrix which is either a zero matrix or a circulant matrix. This is a generalization of a cyclic code in which a cyclic shift of a codeword by 1 results in another codeword. The block of p×p matrix can be a zero matrix or cyclically shifted identity matrix of size p×p.

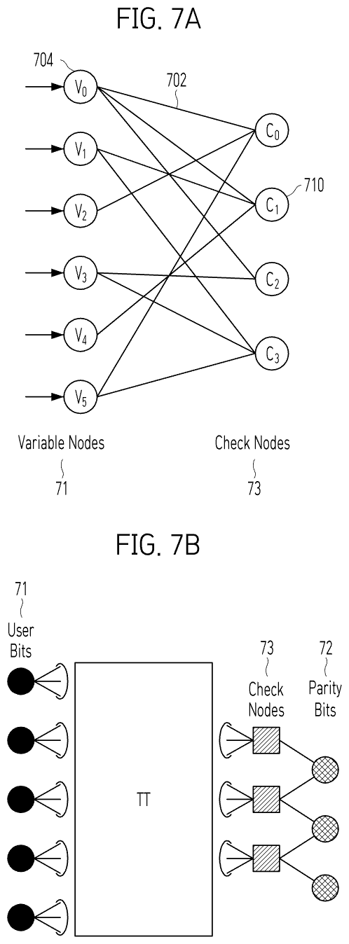

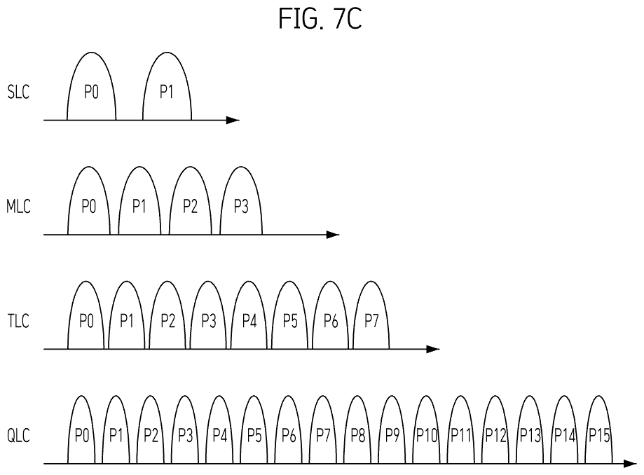

FIG. 6 illustrates an example parity-check matrix H 600, and FIG. 7A illustrates an example bipartite graph corresponding to the parity-check matrix 600.

As shown in FIG. 6, the illustrative parity-check matrix 600 has six column vectors and four row vectors. Network 702 shown in FIG. 7A shows the network corresponding to the parity-check matrix 600 and represent a bipartite graph. Various types of bipartite graphs are possible, including, for example, a Tanner graph. A Tanner graph representation of an LDPC code, with user bits 71, parity bits 72 and check nodes 73, is shown in FIG. 7B.

In general, the variable nodes in network 702 correspond to the column vectors in the parity-check matrix 600. The check nodes in network 702 correspond to the row vectors of the parity-check matrix 600. The interconnections between the nodes are determined by the values of the parity-check matrix 200. Specifically, a “1” indicates the corresponding check node and variable nodes have a connection. A “0” indicates there is no connection. For example, the “1” in the leftmost column vector and the second row vector from the top in the parity-check matrix 600 corresponds to the connection between the variable node 704 and the check node 710.

A message passing algorithm may be used to decode LDPC codes. Several variations of the message passing algorithm exist in the art, such as min-sum (MS) algorithm, sum-product algorithm (SPA) or the like. Message passing uses a network of variable nodes and check nodes, as shown in FIG. 7A.

A hard decision message passing algorithm may be performed. In a first step, each of the variable nodes sends a message to one or more check nodes that are connected to it. In this case, the message is a value that each of the variable nodes believes to be its correct value.

In the second step, each of the check nodes calculates a response to send to the variable nodes that are connected to it using the information that it previously received from the variable nodes. This step can be referred as the check node update (CNU). The response message corresponds to a value that the check node believes that the variable node should have based on the information received from the other variable nodes connected to that check node. This response is calculated using the parity-check equations which force the values of all the variable nodes that are connected to a particular check node to sum up to zero (modulo 2).

At this point, if all the equations at all the check nodes are satisfied, the decoding algorithm declares that a correct codeword is found and it terminates. If a correct codeword is not found, the iterations continue with another update from the variable nodes using the messages that they received from the check nodes to decide if the bit at their position should be a zero or a one by a majority rule. The variable nodes then send this hard decision message to the check nodes that are connected to them. The iterations continue until a correct codeword is found, a certain number of iterations are performed depending on the syndrome of the codeword (e.g., of the decoded codeword), or a maximum number of iterations are performed without finding a correct codeword.

At each iteration of the decoding, the systematic (user) bits 71 and the low-degree parity bits 72 (such as shown in FIG. 7B), may be decoded alternatively. The user bits 71 may be decoded one-by-one using for example MS operations. The low-degree parity bits may be jointly decoded using the results of the user bits 71. The results from the joint decoding may be used for the next iteration.

FIG. 7C is a diagram illustrating distributions of states or program voltage (PV) levels for different types of cells of a memory device.

Referring to FIG. 7C, each of memory cells may be implemented with a specific type of cell, for example, a single level cell (SLC) storing 1 bit of data, a multi-level cell (MLC) storing 2 bits of data, a triple-level cell (TLC) storing 3 bits of data, or a quadruple-level cell (QLC) storing 4 bits of data. Usually, all memory cells in a particular memory device are of the same type, but that is not a requirement.

An SLC may include two states P0 and P1. P0 may indicate an erase state, and P1 may indicate a program state. Since the SLC can be set in one of two different states, each SLC may program or store 1 bit according to a set coding method. An MLC may include four states P0, P1, P2 and P3. Among these states, P0 may indicate an erase state, and P1 to P3 may indicate program states. Since the MLC can be set in one of four different states, each MLC may program or store two bits according to a set coding method. A TLC may include eight states P0 to P7. Among these states, P0 may indicate an erase state, and P1 to P7 may indicate program states. Since the TLC can be set in one of eight different states, each TLC may program or store three bits according to a set coding method. A QLC may include 16 states P0 to P15. Among these states, P0 may indicate an erase state, and P1 to P15 may indicate program states. Since the QLC can be set in one of sixteen different states, each QLC may program or store four bits according to a set coding method.

Referring back to FIGS. 2 and 3, the memory device 200 may include a plurality of memory cells (e.g., NAND flash memory cells). The memory cells are arranged in an array of rows and columns as shown in FIG. 3. The cells in each row are connected to a word line (e.g., WL0), while the cells in each column are coupled to a bit line (e.g., BL0). These word and bit lines are used for read and write operations. During a write operation, the data to be written (‘1’ or ‘0’) is provided at the bit line while the word line is asserted. During a read operation, the word line is again asserted, and the threshold voltage of each cell can then be acquired from the bit line. Multiple pages may share the memory cells that belong to (i.e., are coupled to) the same word line. When the memory cells are implemented with MLCs, the multiple pages include a most significant bit (MSB) page and a least significant bit (LSB) page. When the memory cells are implemented with TLCs, the multiple pages include an MSB page, a center significant bit (CSB) page and an LSB page. When the memory cells are implemented with QLCs, the multiple pages include an MSB page, a center most significant bit (CMSB) page, a center least significant bit (CLSB) page and an LSB page. The memory cells may be programmed using a coding scheme (e.g., Gray coding) in order to increase the capacity of the memory system 10 such as SSD.

During a read operation, the read processor may read data from the memory device 200, which may include some noise or errors, and perform error correction for the read data, as detailed above. Error correction may include use of LDPC decoding, noted above, as well as bit-flip (BF) decoding and mini-sum (MS) decoding.

Either a soft detector or a hard detector can provide channel information for decoders. For example, a soft detector may output reliability information and a decision for each detected bit. On the other hand, a hard detector may output a hard decision on each bit without providing corresponding reliability information. As an example, a hard detector may output as the hard decision that a particular bit is a “1” or a “0” without indicating how certain or sure the detector is in that decision. In contrast, a soft detector may output a decision and reliability information associated with the decision. In general, reliability information indicates how certain the detector is in a given decision. In one example, a soft detector may output a log-likelihood ratio (LLR) where the sign indicates the decision (e.g., a positive value corresponds to a “1” decision and a negative value corresponds to a “0” decision) and the magnitude indicates how sure or certain the detector is in that decision (e.g., a large magnitude indicates a high reliability or certainty).

### NAND Bit Flipping

In an SSD, LDPC decoder performance is usually tested for the symmetric errors. That is, modeling the SSD write and read process is the equivalent of transmitting a message over a binary symmetric channel. If a NAND page is read at optimal threshold voltages, the number of (detected and corrected) errors from κ to 1 (BER_{0→1}) is almost similar to the number of (detected and corrected) errors from 1 to 0 (BER_{1→0}). However, in practice, a NAND is usually read imperfectly (using history read), which makes the asymmetric ratio of αᵣ=(BER_{0→1}/BER_{1→0}) to be far from 1. In a SSD read process, the inventors have recognized that, in fact, a binary asymmetric channel is present. Accordingly, in one embodiment of the present disclosure, a decoding algorithm utilizes the fact that these errors are asymmetric.

In this disclosure, a memory controller (such as for example memory controller 100 of FIG. 1) is programmed with a bit-flipping algorithm which i) is able to automatically detect the asymmetric ratio αᵣ during decoding, ii) adapt decoder parameters to take advantage of an estimated/detected αᵣ, and iii) provide a BF decoder which can decode both symmetric and asymmetric errors. Simulation results by the inventors show that this novel BF decoder can improve the BF correction capability by 40 bits in region of αᵣ=10, hereinafter referred to as a waterfall region.

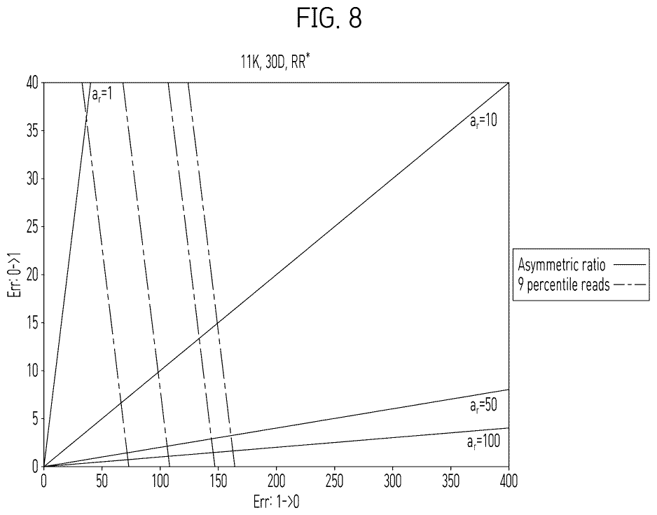

FIG. 8 is a diagram showing the distribution of error rates for all pages of an actual NAND device at an end of life (EOF) condition, that is, program erase cycles (PEC)=11K, retention (Ret) in days=30, where the NAND is read using optimal voltage thresholds (RR*). FIG. 8 shows different asymmetric ratios from αᵣ=1 to αᵣ=100 and shows lines representing 9 percentile reads (that is 90% of reads would have an error lower than these lines. The distribution of error rates is scaled by the number of errors in flipping from “0” to “1” (Y-axis: BER_{0→1}) to the number of errors in flipping from “1” to “0” (X-axis: BER_{1→0}). In other words, for each page, BER_{0→1} and BER_{1→0} are measured, and value of each number is plotted as a coordinate point. As the simulation in FIG. 8 shows (under optimal read conditions), almost all pages experience an asymmetric ratio ranging as 1<αᵣ<10.

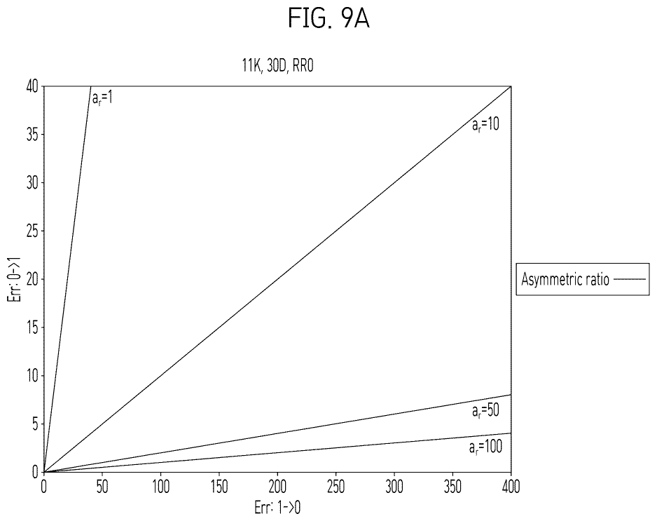

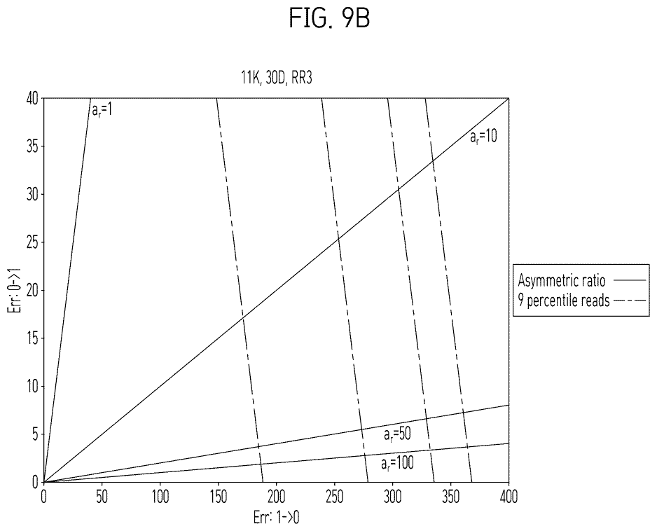

FIGS. 9A and 9B are diagrams of an actual NAND asymmetric ratio where the NAND is read at imperfect voltage thresholds (RR₀, RR₃), that is using history reads. FIG. 9A shows the case for RR₀. FIG. 9B shows the case for RR₃. In that case, the asymmetric ratio is mostly larger than 10 (αᵣ>10). As shown in FIGS. 9A and 9B, when using imperfect read biases (even though some of the imperfect read biases may be predetermined to be read thresholds acceptable for certain types of NAND degradation), the asymmetric ratio can still be larger than 10 (αᵣ>10).

In LDPC decoding, it is known that symmetric errors are the hardest to correct. Thus, the LDPC decoding design is often performed under the assumption of symmetric errors (worst case). Meanwhile, almost all BF algorithms do not take into account asymmetric ratio information, and the correction performance of the conventional BF decoders does not change between binary symmetric channels (BSC) and binary asymmetric channels (BAC).

### Existing BF Decoder

Existing BF decoders can be summarized as follows:
Energy function: for each variable node ν (for example variable nodes in network 702 in FIG. 7A) at iteration (i), the energy function is the flipping energy and can be considered a sum of neighboring unsatisfied check nodes+channel mismatch such that the energy at each variable node ν iteration is represented as:

$${E}_{v}^{( i )} = {\sum }_{{c}_{k} ∈ N ( v )} {c}_{k} + 𝕝 ( {y}_{v} \neq h {d}^{( i )} ( v ) )$$

where

$${E}_{v}^{( i )}$$

is the flipping energy of variable node ν at decoding iteration i.
Compare the energy

$${E}_{v}^{( i )}$$

at each variable node ν iteration with a BF threshold T⁽ⁱ⁾ where T⁽ⁱ⁾ is the optimal threshold at iteration i. This threshold usually depends on (is a function of) decoding iteration, current checksum and degree of variable nodes.
If

$${E}_{v}^{( i )} > {T}^{( i )} ,$$

flip the hard decision value hd(ν).
To improve performance, the BF threshold T⁽ⁱ⁾ is often obtained by optimizing the BF threshold T⁽ⁱ⁾ for different conditions (e.g., different combinations of decoder status and variable node properties) in offline models and stored in a threshold table accessible by a memory controller.

### Novel BF Decoder for Binary Asymmetric Channels (BAC)

The following shows at least two features of the novel BF decoder of the present disclosure. These features provide the capability to improve the codeword failure rate (CFR) performance when a large asymmetric ratio (for example between 5 and 20 or 5 and 100) exists.

### A. Asymmetric Ratio Detection Method

In this stage, assuming that an optimized BF decoder (for a symmetric channel) exists. To detect the asymmetric ratios:
i. Run the symmetric decoder for at least one decoding iteration
ii. Let

$${n}_{f}^{( i )} ( 0 \to 1 )$$

be the number or decoding flips from y=0→hd=1 at iteration i. Capture information for both

$${n}_{f}^{( i )} ( 0 \to 1 ) and {n}_{f}^{( i )} ( 1 \to 0 ) .$$

iii. αᵣ can be estimated by comparing

$${\hat{α}}_{r}^{( i )} = \frac{{n}_{f}^{( i )} ( 0 \to 1 )}{{n}_{f}^{( i )} ( 1 \to 0 )}$$

with a BF threshold.

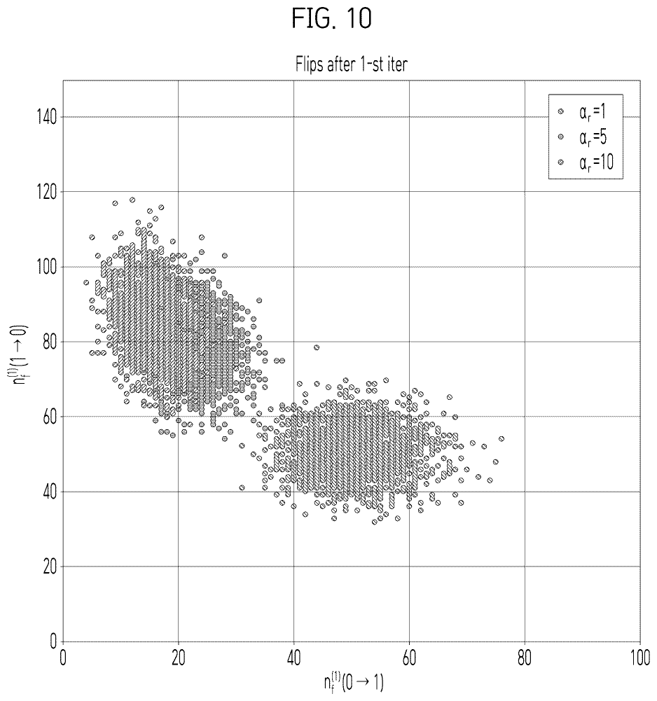

FIG. 10 shows how the estimated

$${n}_{f}^{( 1 )}$$

can be used as a good estimator for identifying an asymmetric ratio. In FIG. 10, the information from the first iteration of the symmetric BF decoder class of samples with αᵣ=1 is completely separate from the class of samples with αᵣ=10.

### B. BF Decoder Parameter Optimization for BAC

If the estimated asymmetric ratio

$${\hat{α}}_{r}^{( i )}$$

is large, the BF decoder is modified as follows:
Use a separate energy function for the bit values y=0 and y=1. That is:

$${E}_{v}^{( i )} ( {y}_{v} = 0 ) = ( {\sum }_{{c}_{k} ∈ N ( v )} {c}_{k} + {w}_{0}^{( i )} \cdot 𝕀 ( {hd}^{( i )} ( v ) \neq 0 ) )$$

$${E}_{v}^{( i )} ( {y}_{v} = 1 ) = ( {\sum }_{{c}_{k} ∈ N ( v )} {c}_{k} + {w}_{1}^{( i )} \cdot 𝕀 ( {hd}^{( i )} ( v ) \neq 1 ) )$$

In this part, flipping energy

$${E}_{v}^{( i )}$$

for the variable nodes are separated into two groups. The new flipping energy is sum of unsatisfied checknodes+

$${w}_{y}^{( i )}$$

* channel mismatch, where

$${w}_{y}^{( i )}$$

is a weighting factor. In original symmetric decoder,

$${w}_{y}^{( i )}$$

may be equal to 1, while here this weighting factor could be different depending on received value y (the channel value for a variable node ν) and also depending on the decoding iteration.
Compare energy calculated to a BF threshold

$${T}_{0}^{( i )} .$$

If

$${E}_{v}^{( i )} ( y = 0 ) > {T}_{0}^{( i )} and {E}_{v}^{( i )} ( y = 1 ) > {T}_{1}^{( i )} ,$$

flip the hard decision value hd(ν).
To improve performance, use the same offline optimization scheme (noted above) to obtain the threshold

$${T}_{0}^{( i )} , {w}_{0}^{( i )} and {T}_{1}^{( i )} , {w}_{1}^{( i )}$$

and store these values in separate tables for memory controller access. The optimal numbers for both

$${w}^{{w}_{y}^{( i )} and {T}_{y}^{( i )}}$$

can be obtained by Monte-Carlo simulation (greedy optimization).

### C. Enabling Asymmetric BF Decoding Using Checksum

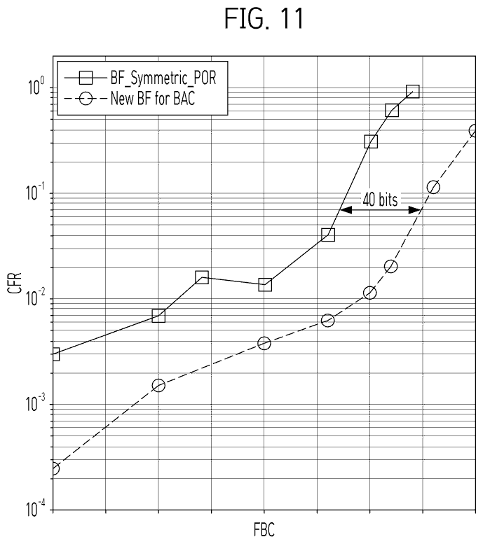

In order to keep a symmetric decoder intact, a checksum can be used to provide asymmetric handling when the failed bit count (FBC) is out of correction capability of the symmetric BF decoder. For example, considering FIG. 11 for the upper most FBC, the CFR for the symmetric decoder is almost 1, which means that the symmetric BF decoder will fail, as the FBC is out of the correction capability for symmetric decoder. In one embodiment, if the checksum during symmetric iterations is larger than symmetric BF correction capability, the asymmetric BF decoder is used to handle the decoding. Otherwise, when the checksum during symmetric iterations is smaller than the symmetric BF correction capability, the symmetric BF decoder is used.

### Pseudocode for Novel BF Algorithm

Suppose

$${d}^{( - 1 )} = [ {d}_{0}^{( - 1 )} , {d}_{1}^{( - 1 )} , … , {d}_{n - 1}^{( - 1 )} ] = y$$

be the initial hard decision obtained from the received sequence y. Let

$${syn}^{( i )} = [ {d}_{0}^{( i )} , {d}_{1}^{( i )} , … , {d}_{n - 1}^{( i )} ] \times {H}^{T}$$

represents syndrome at each iteration i, csᵢ=∥syn⁽ⁱ⁾∥. The modified BF algorithm is described as following:

```
•  Step 0: Set iter = 0, calculate syn⁽⁻¹⁾ and go to step 1;
•  Step 1: iter = iter + 1, if reach max iteration, stop decoding.
  Otherwise, go to step 2;
$\cdot Step 2 \text{:} set {n}_{f}^{( i )} ( 1 \to 0 ) = 0 , {n}_{f}^{( i )} ( 0 \to 1 ) = 0$
  if cs^{(iter)} = 0, stop decoding. Otherwise, go to step 3.
•  Step 3: if iter < limit [symbol] :
    ○ Set decoder_mode = symmetric.
•  Step 4: for all variable nodes v:
    ○ If decoder_mode = = symmetric:
        $\cdot If {E}_{v}^{( iter )} = {\sum }_{{c}_{k} ∈ N ( v )} {c}_{k} + 〛 ( {y}_{v} \neq {hd}^{( iter )} ( v ) ) > {T}_{v}^{( iter )} ( that$
          is if a first sum of unsatisfied neighboring check nodes
          in a parity check matrix and a channel mismatch is
          greater than a first predetermined threshold)
            •  Flip variable node v.
            $\cdot Increase either {n}_{f}^{( i )} ( 1 \to 0 ) or {n}_{f}^{( i )} ( 0 \to 1 )$
              depending on yᵥ by one
            $\cdot Update estimate of {\hat{α}}_{r}^{( i )} = \frac{{n}_{f}^{( i )} ( 0 \to 1 )}{{n}_{f}^{( i )} ( 1 \to 0 )}$
            $\cdot At end of iteration if {\hat{α}}_{r}^{( i )} >> 1 or \frac{1}{{\hat{α}}_{r}^{( i )}} >> 1:$
                ○ Set decoder_mode = asymmetric
    ○ If decoder_mode = = asymmetric:
      • If yᵥ = = 0:
            $\cdot Set w = {w}_{0}^{( iter )} , T = {T}_{0}^{( iter )}$
      •  Else:
            $\cdot Set w = {w}_{1}^{( iter )} , T = {T}_{1}^{( iter )}$
      $\cdot {E}_{v}^{( iter )} ( y ) = {\sum }_{{c}_{j} ∈ N ( v )} {c}_{j} + w \cdot 〛 ( {y}_{v} \neq {hd}^{( iter )} ( v ) ) > T ( that is$
        a second sum of the unsatisfied neighboring check
        nodes in the parity check matrix and a weighted
        channel mismatch is greater than a second
        predetermined threshold)
            •  Flip variable node v.
•  Step 5: go to step 1.
```

FIG. 11 shows the performance of the novel BF algorithm in comparison to an original BF algorithm for symmetric channels. In this simulation, the following asymmetric ratios as are

$${\hat{a}}_{r}^{( i )} > 3$$

as

$${\hat{a}}_{r}^{( i )} >> 1$$

are considered against a proof of record (POR) of an existing BF symmetric decoder. These simulation results (showing CFR vs. FBC) show that the novel BF decoder can improve the BF correction capability by 40 bits in the waterfall region of αᵣ=10.

### Operational Methods

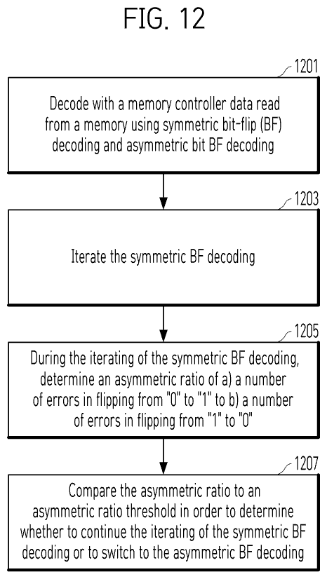

FIG. 12 is a flowchart depicting a method for reading data from a memory in accordance with one embodiment of the present invention. As illustrated in FIG. 12, at 1201, the method decodes with a memory controller the data read from the memory using symmetric bit-flip (BF) decoding and asymmetric bit BF decoding. At 1203, the method iterates the symmetric BF decoding. At 1205, the method during the iterating of the symmetric BF decoding, determines an asymmetric ratio of a) a number of errors in flipping from “0” to “1” to b) a number of errors in flipping from “1” to “0”.

At 1207, the method compares the asymmetric ratio to an asymmetric ratio threshold in order to determine whether to continue the iterating of the symmetric BF decoding or to switch to the asymmetric BF decoding.

In one aspect of this method, the method, at an end of a first number of iterations of the symmetric BF decoding, if the asymmetric ratio is greater than the asymmetric ratio threshold, can switch to the asymmetric BF decoding for decoding the data read from the memory. The method, at the end of the first number of iterations of the symmetric BF decoding, if the asymmetric ratio is less than the asymmetric ratio threshold, can continue symmetric BF decoding for decoding the data read from the memory.

In one aspect of this method, the method can automatically detect the asymmetric ratio during the decoding.

In one aspect of this method, the method can determine hard decisions for bit flipping by comparing energy functions to a BF energy threshold.

In one aspect of this method, the method can determine if an error rate for decoding with the symmetric BF decoding is larger than a correction capability of the symmetric BF decoding, and can utilize the asymmetric BF decoding for decoding if the error rate is larger than the correction capability of the symmetric BF decoding.

In one aspect of this method, the method, for the symmetric BF decoding, can flip a hard decision value when a first sum of neighboring check nodes in a parity check matrix and a channel mismatch is greater than a first threshold.

In one aspect of this method, the method, for the asymmetric BF decoding, can flip a hard decision value when a second sum of the neighboring check nodes in the parity check matrix and a weighted channel mismatch is greater than a second threshold.

In one aspect of this method, the method can adapt decoder parameters based on the estimated asymmetric ratio.

In one aspect of this method, the adapting can comprise utilizing different values of weighting factors for the weighted channel mismatch depending on a magnitude on the asymmetric ratio.

In one aspect of this method, the adapting can comprise utilizing different values for the first and second thresholds depending on a magnitude on the asymmetric ratio.

### Memory System

In the present invention, there is provided a memory system comprising a memory device, a controller in communication with and configured to control the memory device. The controller is configured to a) decode with a memory controller the data read from the memory using symmetric bit-flip (BF) decoding and asymmetric bit BF decoding, b) iterate the symmetric BF decoding, c) during the iterating of the symmetric BF decoding, determine an asymmetric ratio of a) a number of errors in flipping from “0” to “1” to b) a number of errors in flipping from “1” to “0”, and d) compare the asymmetric ratio to an asymmetric ratio threshold in order to determine whether to continue the iterating of the symmetric BF decoding or to switch to the asymmetric BF decoding.

In one aspect of this system, the controller is configured to, at an end of a first number of iterations of the symmetric BF decoding and if the asymmetric ratio is greater than the asymmetric ratio threshold, switch to the asymmetric BF decoding for decoding the data read from the memory. The controller is also configured to, at the end of the first number of iterations of the symmetric BF decoding, if the asymmetric ratio is less than the asymmetric ratio threshold, continue symmetric BF decoding for decoding the data read from the memory.

In one aspect of this system, the controller is configured to automatically detect the asymmetric ratio during the decoding.

In one aspect of this system, the controller is configured to determine hard decisions for bit flipping by comparing energy functions to a BF energy threshold.

In one aspect of this system, the controller is configured to determine if an error rate for decoding with the symmetric BF decoding is larger than a correction capability of the symmetric BF decoding, and to utilize the asymmetric BF decoding for decoding if the error rate is larger than the correction capability of the symmetric BF decoding.

In one aspect of this system, the controller is configured to, for the symmetric BF decoding, flip a hard decision value when a first sum of neighboring check nodes in a parity check matrix and a channel mismatch is greater than a first threshold.

In one aspect of this system, the controller is configured to, for the asymmetric BF decoding, flip a hard decision value when a second sum of the neighboring check nodes in the parity check matrix and a weighted channel mismatch is greater than a second threshold.

In one aspect of this system, the controller is configured to adapt decoder parameters based on the estimated asymmetric ratio.

In one aspect of this system, the controller is configured to utilize different values of weighting factors for the weighted channel mismatch depending on a magnitude on the asymmetric ratio.

In one aspect of this system, the controller is configured to utilize different values for the first and second thresholds depending on a magnitude on the asymmetric ratio,

Although the foregoing embodiments have been described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive.

What is claimed is:

1. A method for decoding data read from a memory, comprising:
decoding with a memory controller the data read from the memory using symmetric bit-flip (BF) decoding and asymmetric BF decoding;
iterating the symmetric BF decoding;
during the iterating of the symmetric BF decoding, determining an asymmetric ratio of a) a number of errors in flipping from “0” to “1” to b) a number of errors in flipping from “1” to “0”; and
comparing the asymmetric ratio to an asymmetric ratio threshold in order to determine whether to continue the iterating of the symmetric BF decoding or to switch to the asymmetric BF decoding.

2. The method of claim 1, further comprising:
at an end of a first number of iterations of the symmetric BF decoding, when the asymmetric ratio is greater than the asymmetric ratio threshold, switching to the asymmetric BF decoding for decoding the data read from the memory device; and
at the end of the first number of iterations of the symmetric BF decoding, when the asymmetric ratio is less than the asymmetric ratio threshold, continuing the symmetric BF decoding for decoding the data read from the memory device.

3. The method of claim 1, further comprising automatically detecting the asymmetric ratio during the decoding.

4. The method of claim 1, further comprising determining hard decisions for bit flipping by comparing energy functions to a BF energy threshold.

5. The method of claim 1, further comprising:
determining whether an error rate for decoding with the symmetric BF decoding is larger than a correction capability of the symmetric BF decoding; and
utilizing the asymmetric BF decoding for decoding, when it is determined that the error rate is larger than the correction capability of the symmetric BF decoding.

6. The method of claim 5, further comprising: for the symmetric BF decoding
flipping a hard decision value when a first sum of neighboring check nodes in a parity check matrix and a channel mismatch is greater than a first threshold.

7. The method of claim 6, further comprising: for the asymmetric BF decoding,
flipping a hard decision value when a second sum of the neighboring check nodes in the parity check matrix and a weighted channel mismatch is greater than a second threshold.

8. The method of claim 7, further comprising
adapting decoder parameters based on the asymmetric ratio.

9. The method of claim 8, wherein the adapting comprises utilizing different values of weighting factors for the weighted channel mismatch depending on a magnitude on the asymmetric ratio.

10. The method of claim 8, wherein the adapting comprises utilizing different values for the first and second thresholds depending on a magnitude on the asymmetric ratio.

11. A memory system comprising:
a memory device; and
a controller in communication with the memory device, and configured to:
decode the data read from the memory using symmetric bit-flip (BF) decoding and asymmetric BF decoding;
iterate the symmetric BF decoding;
during the iterating of the symmetric BF decoding, determine an asymmetric ratio of a) a number of errors in flipping from “0” to “1” to b) a number of errors in flipping from “1” to “0”; and
compare the asymmetric ratio to an asymmetric ratio threshold in order to determine whether to continue the iterating of the symmetric BF decoding or to switch to the asymmetric BF decoding.

12. The memory system of claim 11, wherein the controller is configured to:
at an end of a first number of iterations of the symmetric BF decoding and when the asymmetric ratio is greater than the asymmetric ratio threshold, switch to the asymmetric BF decoding for decoding the data read from the memory device; and
at the end of the first number of iterations of the symmetric BF decoding, if the asymmetric ratio is less than the asymmetric ratio threshold, continue symmetric BF decoding for decoding the data read from the memory device.

13. The memory system of claim 12, wherein the controller is configured to automatically detect the asymmetric ratio during the decoding.

14. The memory system of claim 12, wherein the controller is configured to determine hard decisions for bit flipping by comparing energy functions to a BF energy threshold.

15. The memory system of claim 11, wherein the controller is configured to determine whether an error rate for decoding with the symmetric BF decoding is larger than a correction capability of the symmetric BF decoding; and
utilize the asymmetric BF decoding for decoding, when it is determined that the error rate is larger than the correction capability of the symmetric BF decoding.

16. The memory system of claim 15, wherein the controller is configured to, for the symmetric BF decoding, flip a hard decision value when a first sum of neighboring check nodes in a parity check matrix and a channel mismatch is greater than a first threshold.

17. The memory system of claim 15, wherein the controller is configured to, for the asymmetric BF decoding, flip a hard decision value when a second sum of the neighboring check nodes in the parity check matrix and a weighted channel mismatch is greater than a second threshold.

18. The memory system of claim 15, wherein the controller is configured to adapt decoder parameters based on the asymmetric ratio.

19. The memory system of claim 18, wherein the controller is configured to utilize different values of weighting factors for the weighted channel mismatch depending on a magnitude on the asymmetric ratio.

20. The memory system of claim 18, wherein the controller is configured to utilize different values for the first and second thresholds depending on a magnitude on the asymmetric ratio.
